(19) United States
(12) Patent Application Publication
(10) Pub. No.: US 2014/0050452 A1
(43) Pub. Date: Feb. 20, 2014

(54) CABLE CLOSURE

(71) Applicant: CCS Technology, Inc., Wilmington, DE (US)

(72) Inventors: Stefan Badura, Menden (DE); Mike Breuer-Heckel, Dortmund (DE); Lars Kittler, Schwerte (DE)

(73) Assignee: CCS Technology, Inc., Wilmington, DE (US)

(21) Appl. No.: 14/066,979

(22) Filed: Oct. 30, 2013

Related U.S. Application Data
(63) Continuation of application No. PCT/US12/36064, filed on May 2, 2012.

(30) Foreign Application Priority Data
May 5, 2011 (EP) 11164928.1

(51) Int. Cl. G02B 6/44

(52) U.S. Cl. CPC G02B 6/4439
USPC 385/135

(57) ABSTRACT

A cable closure includes a housing delimiting an interior of the cable closure. The housing includes a covering body having cable insertion regions on opposite sides and shells that each have, at the cable insertion regions, a barrier wall associated with the interior of the cable closure and a barrier wall remote from the interior of the cable closure. Deformable sealing elements are positioned in the cable insertion regions, there being a deformable sealing element associated with each shell at each cable insertion region positioned between the barrier wall associated with the interior of the cable closure and the barrier wall remote from the interior of the cable closure. At least one of the barrier walls of each of the shells includes a first segment fixedly attached to the respective shell and at least one second segment detachable from the first segment.

### CROSS-REFERENCE TO RELATED APPLICATIONS

This application is a continuation under 35 U.S.C. §120 of International Application No. PCT/US12/36064, filed on May 2, 2012, which in turn claims the benefit of priority under 35 U.S.C. §119 of European Patent Application Serial No. 11164928, filed on May 5, 2011, both applications being incorporated herein by reference in their entirety.

### BACKGROUND

The disclosure relates to cable closures, and particularly to cable closures having removable gel retaining walls.

Cable closures are used in telecommunications cable networks for protecting spliced joints at connection points between two telecommunications cables and for protecting branch points or splitting points of telecommunications cables. In this case, the cable closures need to ensure the continuity of the telecommunications cables as though the telecommunications cables had not been interrupted.

The product catalog “Accessories for Fiber Optic Networks”, Edition 1, page 75, Corning Cable Systems, 2001 discloses cable closures firstly in the form of inline cable closures and secondly in the form of dome cable closures, which all have a housing which defines an interior of the cable closure and seals off the interior thereof from the outside. Conventionally, assemblies for connecting, namely for splicing, telecommunications conductors guided in telecommunications cables are arranged in the interior defined by the housing of the cable closure.

In the case of cable closures in the form of dome cable closures, the housing is formed by a dome-like covering body and a sealing body, the sealing body defining cable insertion regions, which are sealed off on one side of the dome-like covering body and via which all of the cables can be inserted into the interior of the cable closure.

In the case of cable closures in the form of inline cable closures, cable insertion regions which are sealed off on two opposite sides of the covering body are formed for inserting cables into the interior of the cable closure, with the result that inline cable closures can be installed in one line with the cables.

DE 20 2010 006 582 U1 discloses an inline cable closure, having a housing, which delimits an interior of the cable closure and seals off the cable closure toward the outside, the housing comprising a covering body, the covering body comprises shells and provides on mutually opposite sides of the same cable insertion regions for inserting cables into the interior of the cable closure and/or for passing cables out of the interior of the cable closure. According to DE 20 2010 006 582 U1 compressible and/or deformable sealing elements are positioned at the mutually opposite sides of the covering body in the region of the cable insertion regions of the shells, wherein each of the sealing elements is positioned between barrier walls of the respective shell, namely between a barrier wall facing the interior of the cable closure and a barrier wall remote from the interior of the cable closure.

### SUMMARY

According to one embodiment, a cable closure includes a housing delimiting an interior of the cable closure and sealing off the cable closure toward the outside. The housing includes a covering body having cable insertion regions on opposite sides for inserting cables into the interior of the cable closure or for passing cables out of the interior of the cable closure. The covering body also has shells that each have, at the cable insertion regions, a barrier wall associated with the interior of the cable closure and a barrier wall remote from the interior of the cable closure. Deformable sealing elements are positioned in the cable insertion regions, there being a deformable sealing element associated with each shell at each cable insertion region positioned between the barrier wall associated with the interior of the cable closure and the barrier wall remote from the interior of the cable closure. At least one of the barrier walls of each of the shells includes a first segment fixedly attached to the respective shell and at least one second segment detachable from the first segment.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

Exemplary embodiments of the disclosure will be explained in more detail, with-out any restriction being imposed, with reference to the drawings, in which:

FIG. 1 is a perspective view of a cable closure in the form of an inline cable closure in a closed status of the same;

FIG. 2 is a perspective view of the inline cable closure shown in FIG. 1 in an opened status of the same;

FIG. 3 is a detail of a first, lower shell of the inline cable closure;

FIG. 4 is another detail of the first, lower shell of the inline cable closure;

FIG. 5 is the detail of FIG. 4 in a second status;

FIG. 6 is a first perspective view of a detachable segment of a barrier wall; and

FIG. 7 is a second perspective view of the detachable segment of FIG. 6.

### DETAILED DESCRIPTION

Reference is now made in detail to the embodiments of the disclosure, examples of which are illustrated in the accompanying drawings. Whenever possible, identical or similar reference numerals are used throughout the drawings to refer to identical or similar parts. It should be understood that the embodiments disclosed herein are merely examples with each one incorporating certain benefits of the present disclosure. Various modifications and alterations may be made to the following examples within the scope of the present disclosure, and aspects of the different examples may be mixed in different ways to achieve yet further examples. Accordingly, the true scope of the disclosure is to be understood from the entirety of the present disclosure in view of, but not limited to the embodiments described herein.

The present disclosure relates to a cable closure 10, which in the exemplary embodiment shown is an inline cable closure comprises a housing which is formed by a covering body 13 composed of two shells 11 and 12.

In the exemplary embodiment shown, the shells 11 and 12 are half-shells and the half-shell 11 is a so-called lower shell and the half-shell 12 is a so-called upper shell of the covering body 13, which together define an interior 14 of the inline cable closure 10.

Cable insertion regions 17 are formed on mutually opposite sides 15 and 16 of the inline cable closure 10 or the covering body 13, with it being possible for cables to be inserted into the interior 14 of the inline cable closure 10 or passed out of the interior. In the exemplary embodiment shown, in each case two cable insertion regions 17 for inserting in each case one cable into the interior 14 of the inline cable closure 10 are formed on both mutually opposite sides 15 and 16 of the covering body 13.

In the shown embodiment, the two half-shells 11 and 12 are hinged together at first longitudinal sides 18, 19 of the same. The half-shells 11 and 12 can be pivoted with respect to each other around a hinge 20 by which the two half-shells 11 and 12 are fixed to each other at the first longitudinal sides 18, 19 of the same. When the inline cable closure 10 is closed, the other second longitudinal sides 21, 22 of the two half-shells 11 and 12 can be secured to each other by a closing mechanism 23, which is in the shown embodiment assigned to the lower half-shell 11.

In order to ensure that the cables to be inserted into the interior 14 of the inline cable closure 10 via the cable insertion regions 17 are sealed off, compressible and/or deformable sealing elements 24, which are each arranged between barrier walls 25 and 26, are positioned in the region of both mutually opposite sides 15 and 16 of the covering body 13 of the inline cable closure 10 on which the cable insertion regions 17 are formed, both in the region of the lower half-shell 11 and in the region of the upper half-shell 12. A first barrier wall 25 is in each case, namely on both mutually opposite sides 15 and 16 in the region of the lower half-shell 11 and in the region of the upper half-shell 12, remote from the interior 14 of the inline cable closure 10 while a second barrier walls 26 is in each case facing the interior 14 of the cable closure 10.

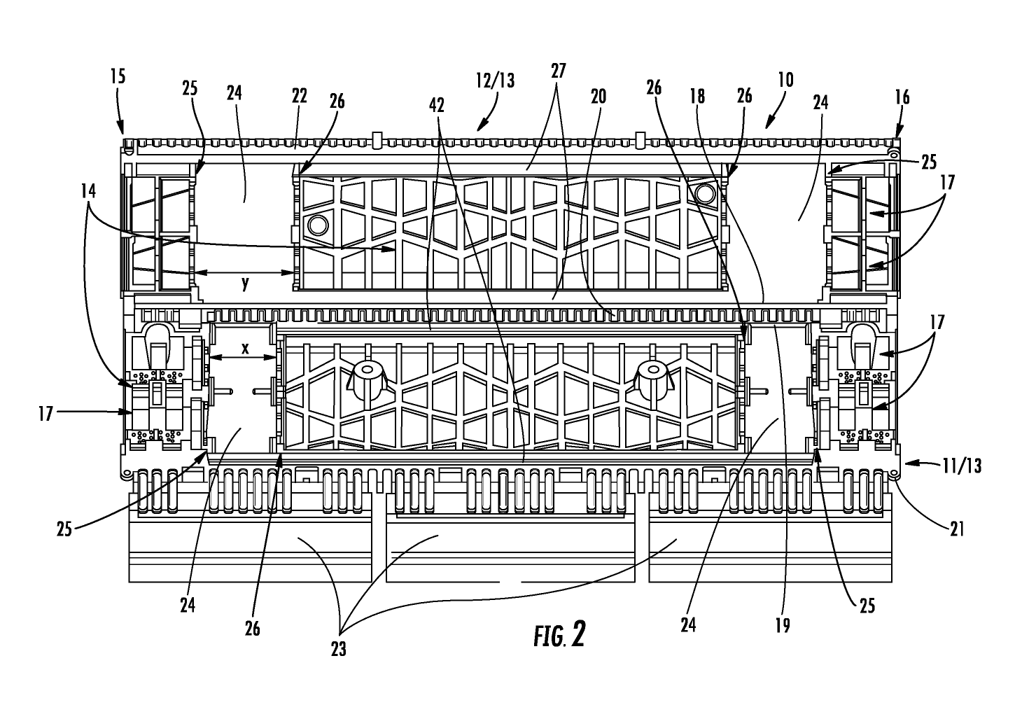

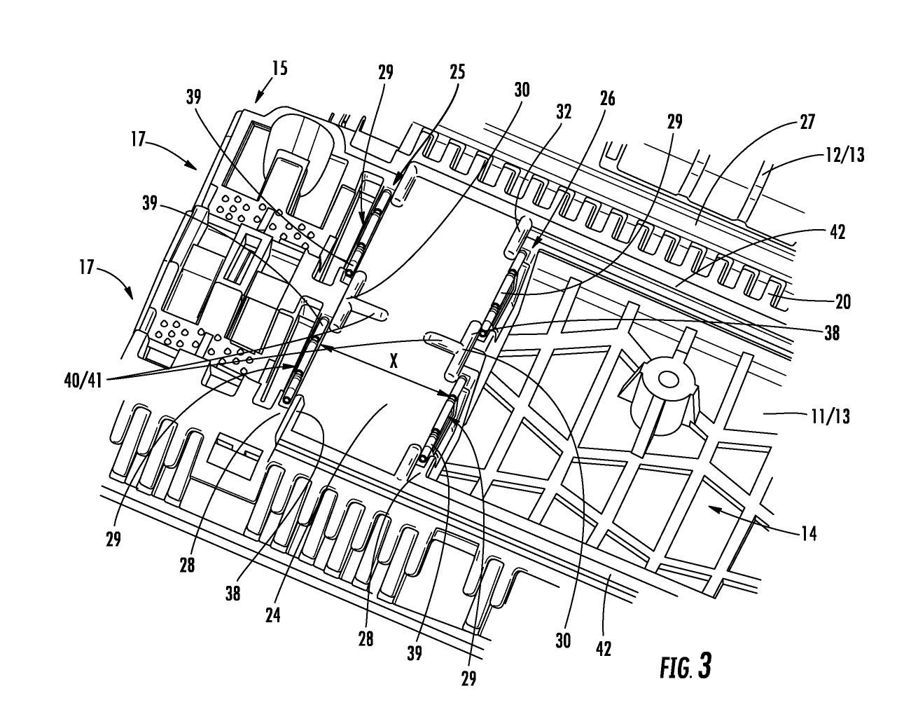

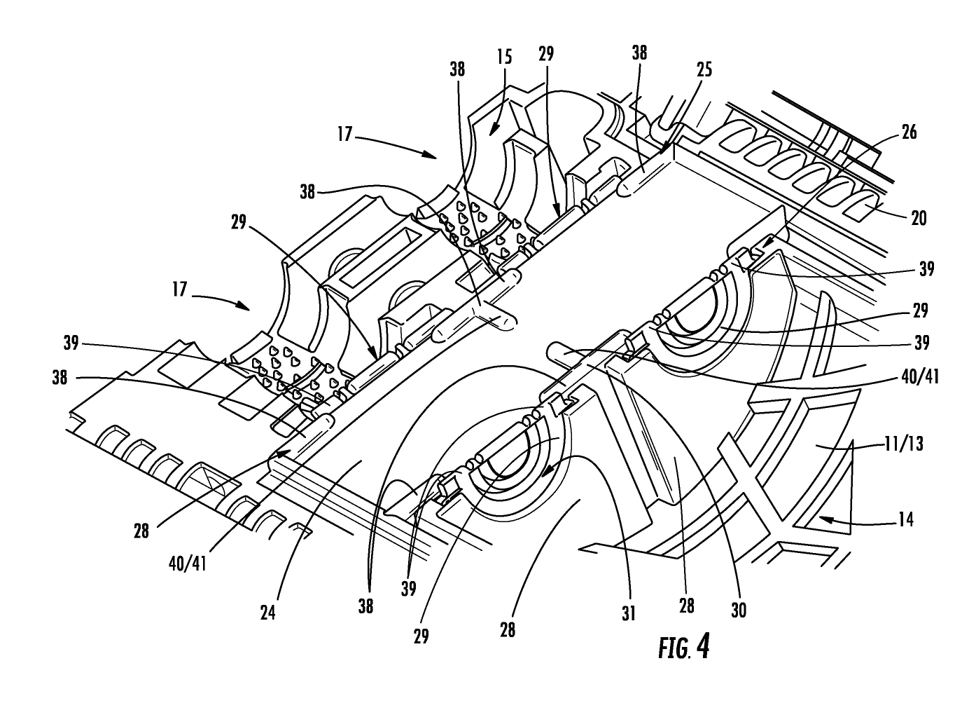

As shown in FIG. 2, the compressible and/or deformable sealing elements 24 of the upper half-shell 12, which are associated with the cable insertion regions 17, are coupled via compressible and/or deformable sealing elements 27, which run parallel to longitudinal sides 18, 22 of the upper half-shell 12. As a result, an annular, closed sealing region is formed by the sealing elements 24 and 27 in the region of the upper half-shell 12. Possibly, an analogous sealing region can also be formed in the region of the lower half-shell 11.

The compressible and/or deformable sealing elements 24 and possibly 27 are preferably gel-like sealing elements, for example polyurethane gels or silicone gels. Such gel-like sealing elements are deformable and can be compressible.

It is also possible to use sealing elements 24 which are partially composed of different materials, for example from a deformable, gel-like sealing material and from a foam-like compressible sealing material.

Each of the barrier walls 25 and 26, namely both the barrier walls 25 remote from the interior 14 and the barrier walls 26 facing the interior 14, extends transversely with respect to an insertion direction of the cable insertion regions 17.

Each of the barrier walls 25 and 26 of the half-shells 11 and 12 comprises a first segment 28 being fixedly attached to the respective half-shell 11, 12 and at least one second segment 29 being detachable from the first segment 28 of the respective barrier wall 25, 26. In the shown embodiment, each of the barrier walls 25 and 26 comprises two second segments 29 being detachable from the first segment 28 of the respective barrier wall 25, 26.

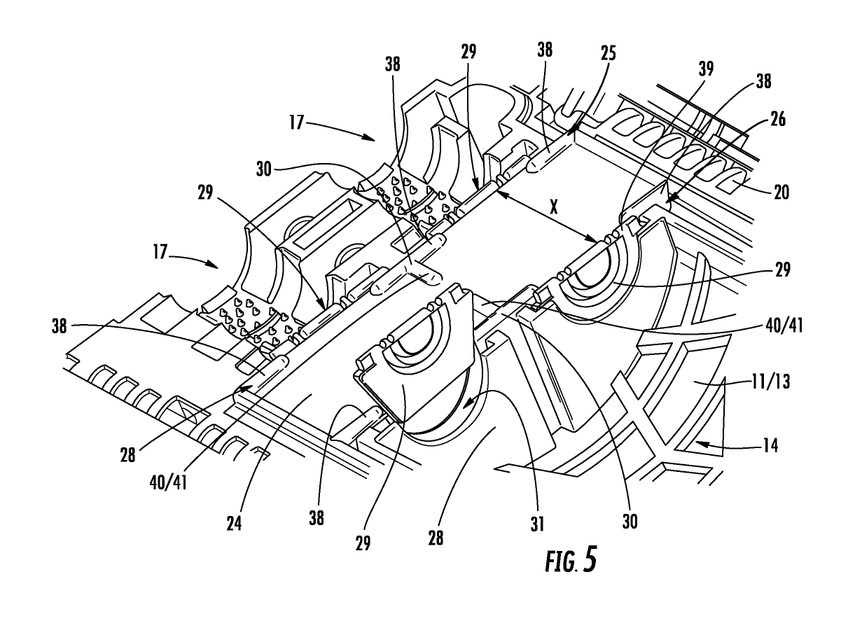

As shown in FIG. 5, the first segment 28 of each barrier walls 25, 26 provides pocket-like openings 31 for receiving the respective second segments 29. The second segments 29 can easily be positioned within the pocket-like openings 31 and can easily be removed from the same.

The first segment 28 of each barrier wall 25, 26 of each of the half-shells 11, 12 extends transversely with respect to the insertion direction of the cable insertion regions 17. The second segments 29 being detachable from the first segment 28 of the respective barrier wall 25, 26 are positioned side by side separated by a middle section 30 of the first segment 28 of the respective barrier wall 25, 26. The second segments 29 of the barrier walls 25, 26 allows an easy and reliable adaption of the inline cable closure 10 to different cable diameters of cables to be handled by the inline cable closure 10 thereby improving the sealing properties of the same.

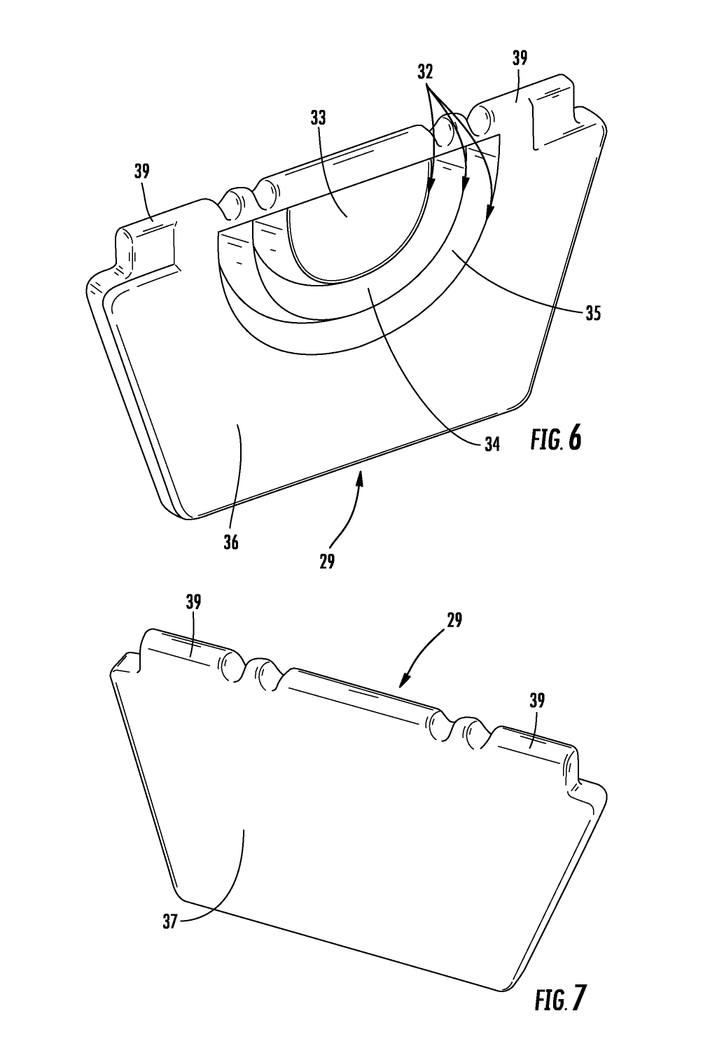

As can be best seen in FIG. 6, each second segment 29 comprises at least one break-out section 33, 34, 35 for adapting the respective second segment 29 to a cable diameter of a cable which is be inserted into the interior of the cable closure and/or passed out of the interior of the cable closure. In the shown embodiment, each second segment 29 comprises three break-out sections 33, 34 and 35. These break-out sections 33, 34 and 35 are arranged concentrically to each other. By breaking out an inner break out section 33, the respective second segment 29 can be adapted to a cable having a relative small cable diameter. By breaking out one of the outer break out sections 34 and/or 35, the respective second segment 29 can be adapted to a cable having a larger cable diameter. By providing a second segment 29 having three concentrically arranged break out sections 33, 34 and 35, the same can be adapted to three different cable diameters.

The break out section 33, 34 and 35 can be broken out from the respective second segment 29 along predetermined breaking points 32 running between adjacent break out sections 33, 34, 35. These predetermined breaking points 32 are assigned to a front wall 36 of the respective second segment 29 and not to a back wall 37 of the same. If the respective second segment 29 is positioned inside one of the pocket-like opening 31 of the respective first segment 28 of the respective barrier wall 25 or 26, the back wall 37 of the respective second segment 29 faces into the direction of the sealing element 24 being positioned between two barrier walls 25 and 26.

As can be best seen in FIG. 2, in the region of each of the mutually opposite sides 15, 16 of a first one of the half-shells 11, 12 of the covering body 13, namely in the region of the lower half-shells 11, the distance x between the respective barrier wall 26 facing the interior 14 of the cable closure and the respective barrier wall 25 remote from the interior 14 of the cable closure 10 is smaller than the respective distance y between the barrier walls 25, 26 in the region of each of the mutually opposite sides 15, 16 of a second one of the half-shells 11, 12 of the covering body 13, namely in the region of the upper half-shells 12.

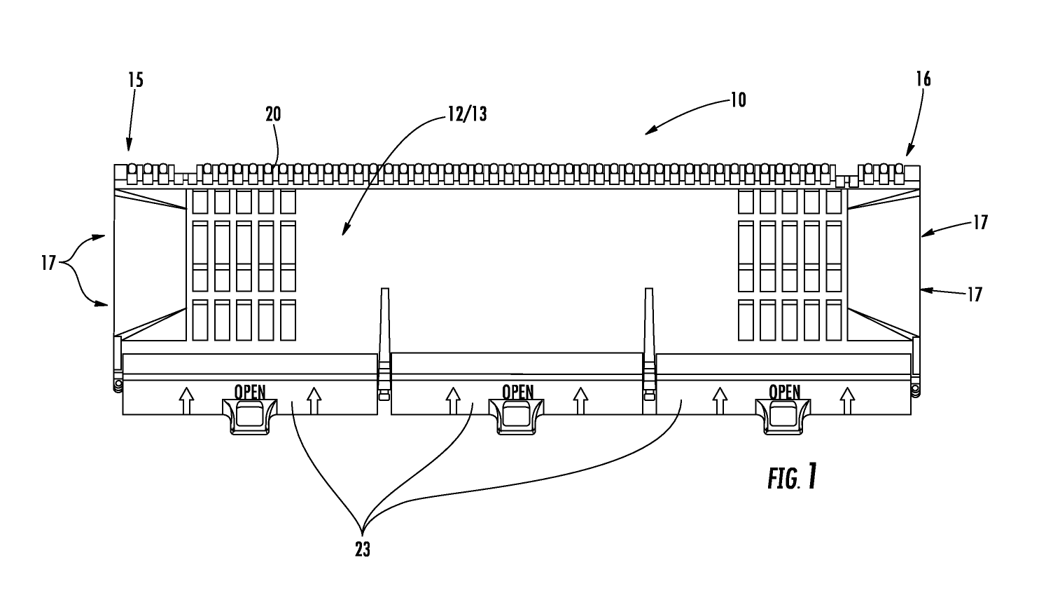

When the covering body 13 of the housing is closed by bringing the half-shells 11 and 12 in the position shown in FIG. 1, edges of the barrier walls 25 and 26 of the first, lower half-shell 11 extending transversely with respect to the insertion direction of the cable insertion regions 17 contact, namely compress and/or deform, the respective compressible and/or deformable sealing element 24 positioned between of the barrier walls 25, 26 of the second, upper half-shell 12.

In the shown embodiment, edges 38 of the first segment 18 of the respective barrier wall 25, 26 and edges 39 of the or each second segment 29 of the respective barrier wall 25, 26 of the first, lower half-shell 11 contact, namely compress and/or deform, the respective compressible and/or deformable sealing element 24 being positioned between the barrier walls 25, 26 of the second, upper half-shell 12 when the the covering body 13 of the housing is closed.

Thereby the compressible and/or deformable sealing element 24 becomes compressed and/or deformed so that the respective cable insertion region 17 is properly sealed even in the case that no cable is to be handled in the respective cable insertion region 17.

The middle sections 30 of the first segments 28 of the barrier walls 25, 26 being positioned between second segments 29 of the respective barrier wall 25, 26 are T-shaped having protrusions 40 running in longitudinal direction with respect to the insertion direction of the cable insertion regions 17. Edges 41 of the protrusions 40 also contact, namely compress and/or deform, the respective compressible and/or deformable sealing element 24 positioned between of the barrier walls 25, 26 of the second, upper half-shell 12 when the cable closure is closed. This provides a further improvement of the sealing properties.

In addition, edges 42 of the lower half-shell 11 running in longitudinal direction contact, namely compress and/or deform, the compressible and/or deformable sealing element 27 running along longitudinal sides 18, 22 of the upper half-shell 12 and/or the compressible and/or deformable sealing elements 24 being positioned between the barrier walls 25, 26 of the upper half-shell 12 when the covering body 13 of the housing is closed. This provides a further improvement of the sealing properties.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A cable closure, comprising:
a housing delimiting an interior of a cable closure and sealing off the cable closure toward the outside, the housing including:
a covering body having cable insertion regions on opposite sides for inserting cables into the interior of the cable closure or for passing cables out of the interior of the cable closure, the covering body including shells that each have at the cable insertion regions a barrier wall associated with the interior of the cable closure and a barrier wall remote from the interior of the cable closure; and
deformable sealing elements positioned in the cable insertion regions, there being a deformable sealing element associated with each shell at each cable insertion region positioned between the barrier wall associated with the interior of the cable closure and the barrier wall remote from the interior of the cable closure;
wherein at least one of the barrier walls of each of the shells includes a first segment fixedly attached to the respective shell and at least one second segment detachable from the first segment.

2. The cable closure of claim 1, wherein the each of the barrier walls of each of the shells includes a first segment fixedly attached to the respective shell and at least one second segment detachable from the first segment.

3. The cable closure of claim 1, wherein the barrier walls of a first one of the shells of the covering body are separated by a distance (x) that is smaller than a distance (y) between the barrier walls of a second one of the shells at the same cable insertion region.

4. The cable closure of claim 3, the barrier walls of the first shell having edges that extend transversely with respect to an insertion direction of the cable insertion regions and that contact the deformable sealing element positioned between the barrier walls of the second shell at the same cable insertion region when the covering body of the housing is closed.

5. The cable closure of claim 1, at least one of the shells further including another deformable sealing element running along longitudinal sides of the covering body so as to form, together with the deformable sealing elements associated with the shell at each cable insertion region, an annular sealing region.

6. The cable closure of claim 5, wherein a second one of the shells has the another deformable sealing element, and further wherein a first one of the shells has edges running in a longitudinal direction that contact both the another deformable sealing element running of the second shell and the deformable sealing elements associated with the second shell that are positioned in the cable insertion regions when the covering body of the housing is closed.

7. The cable closure of claim 1, wherein the first segment of the at least one of the barrier walls extends transversely with respect to an insertion direction of the cable insertion regions, and wherein the at least one second segment includes at least two second segments that are each detachable from the first segment of the at least one of the barrier walls, the at least two second segments being positioned side by side and separated by a middle section of the first segment of the at least one of the barrier walls.

8. The cable closure of claim 7, wherein the middle section of the first segment is T-shaped with at least one protrusion running in a longitudinal direction of the associated cable insertion region.

9. The cable closure of claim 1, wherein the second segment of the each of the at least one of the barrier walls comprises at least one break-out section for adapting the respective second segment to a cable diameter of a cable which is to be inserted into the interior of the cable closure and passed out of the interior of the cable closure.

10. The cable closure of claim 9, wherein the second segment of each barrier wall comprises at least two break-out sections for adapting the respective second segment to a cable diameter of a cable, whereby the break out sections of the second segment of each barrier wall are arranged to each other concentrically so that an inner break out section adapts the respective second segment to relative small cable diameter and that the outer break out section adapts the respective second segment to a larger cable diameter.

11. The cable closure of claim 1, wherein the deformable sealing elements are gel-like sealing elements.
